(19) United States
(12) Patent Application Publication
(10) Pub. No.: US 2011/0261946 A1
(43) Pub. Date: Oct. 27, 2011

(54) HYBRID HOSTING SYSTEM

(75) Inventors: Patrick Conroy, Webster, NY (US); Jeffrey Valentine, Fairport, NY (US)

(73) Assignee: M5 Networks, Inc., New York, NY (US)

(21) Appl. No.: 13/091,793

(22) Filed: Apr. 21, 2011

Related U.S. Application Data
(60) Provisional application No. 61/326,356, filed on Apr. 21, 2010.

(51) Int. Cl. H04M 3/00

(52) U.S. Cl. 379/242

(57) ABSTRACT

Systems, methods and apparatuses of present invention are directed to providing hosted services over a telecommunications network. In one embodiment, the system is comprised of a Cloud Enabling Technology Device (“CETD”) and a Hosted Service Provider. Provisioning and management instructions for the CETD are maintained at the Hosted Service Provider. The CETD may download the provisioning and management instructions, which may be used to control the transmission of voice data received at the CETD over a phone line.

### CROSS-REFERENCE TO RELATED APPLICATIONS

This application claims priority to and the benefit of U.S. Provisional Patent Application Ser. No. 61/326,356, filed on Apr. 21, 2010, which is hereby incorporated herein by reference in its entirety.

### TECHNICAL FIELD

Embodiments of the invention generally relate to hybrid hosting technology, and more specifically to an apparatus, system and method for hybrid hosting of telecommunication services both locally and at remote locations.

### BACKGROUND

Conventional telecommunications systems typically fall into one of two models: (1) the entire system is installed on-site and physically connected to a telecommunications network; and (2) the entire system is hosted such that the telecommunications service as well as the telecommunications applications are provided as a service and little, if any, equipment is local to the user/customer. Other variations exist that still substantially adhere to the two models described above.

Advantages to an on-site type of configuration include, for example: very high call-quality, greater consumer choice for contracting with phone companies, well-understood/low risk decisions, and easier compliance certifications—e.g., private data can stay local which is relevant in HIPAA, PCI DSS, SAS 70, etc.

Disadvantages to an on-site type of configuration include, for example: large, upfront capital expenses to install the hardware; ongoing information-technology and telecommunication resource expenditures; full-replacement costs for upgrading the installation; paying for “high water mark” usage, i.e., customers pay for more than they need and cannot reduce costs if they scale down.

Advantages to a hosted type of configuration include, for example: little or no upfront capital, faster startup time, typically free and easy upgrades, capability for “pay as you go”—e.g., costs increase and decrease as customers/users scale up and down their use.

Disadvantages to a hosted type of configuration include, for example: risk of reliable service interruption if the datacenter of the vendor providing hosted service goes down; quality and security concerns for calls routed over the internet; risk from general misunderstanding of the technology; difficulty complying with data privacy regulations where data is “in the cloud.”

There is a need for a system that provides the advantages of both an on-site configuration and a hosted configuration, but without the above noted disadvantages of either configuration.

### SUMMARY

In embodiments of the invention, an interface is provided that communicates with the on-site telecommunication resources, including phone lines and network (i.e., internet and extranet) lines. Configuration and other provisioning (e.g., instructions for queuing, distributing, or recording calls or other interactions) of the interface is handled by a service hosted at one or more remote datacenters. However, data provided over the phone and network lines is handled on-site without being communicated to the hosted service.

According to the first aspect of the present invention there is provided a method of providing a hybrid hosting service in a telecommunications system. The method includes the steps of receiving provisioning and management instructions from a hosted device at a network interface on a on-premises device; receiving voice call data at a carrier network interface on the on-premises device; and transmitting the received voice call data over a data network based on the received provisioning and management instructions.

According to another aspect of the present invention there is provided a system for providing a hybrid hosting service. The system includes a hosted service provider having provisioning and management instructions maintained thereon; and an on-premises device communicably linked to the hosted service provider and to a carrier network. The on-premise device is configured to: receive the provisioning and management instructions maintained at the hosted service provider; and transmit voice call data received over the telephone network to one or more devices over a local data network based on the received provisioning and management instructions.

According to yet another aspect of the present invention there is provided a device for providing hybrid hosting service in a telecommunications system. The device includes: a network interface configured to receive provisioning and management instructions from a hosted service provider; a carrier network interface configured to receive voice call data; a local data network interface; a provisioning unit configured to control the transmission of the received voice call data to one or more devices over the local data network interface based on the received provisioning and management instructions.

Other aspects of the present invention exist.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a cloud enabling device according to an exemplary embodiment of the present invention.

FIG. 2. is a diagram of a hybrid hosting system according to an exemplary embodiment of the present invention.

FIG. 3 is a flow chart of an exemplary operation of a cloud enabling device according to an embodiment of the present invention.

### DETAILED DESCRIPTION

Described herein are various embodiments of the device, system and method that is the hybrid hosting technology.

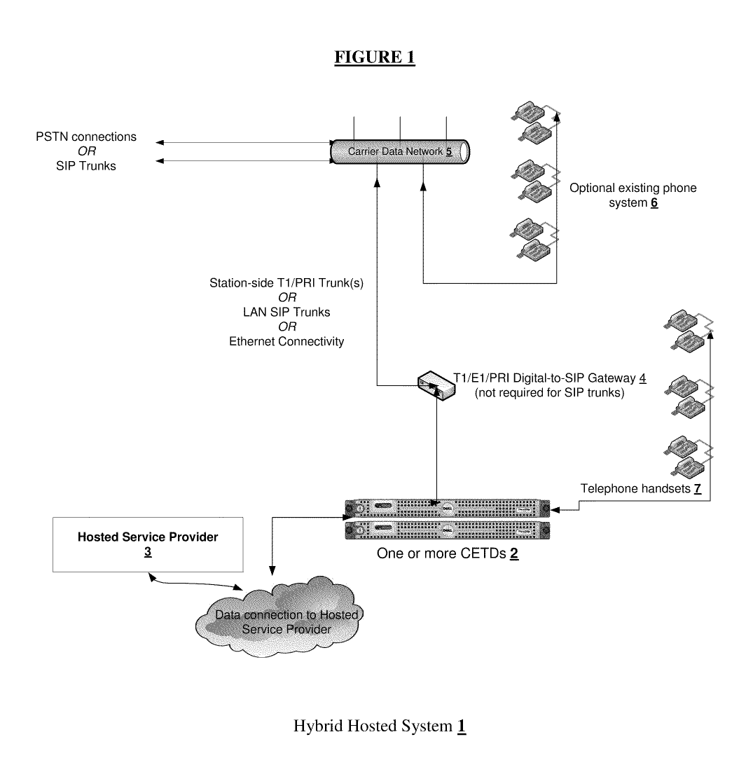

FIG. 1 illustrates a Hybrid Hosted System 1 according to an exemplary embodiment of the present invention. In one exemplary embodiment, the Hybrid Hosted System 1 may include a Cloud Enabling Technology Device 2 (“CETD 2”), a Hosted Service Provider 3, an optional Digital-to-SIP Gateway 4, a Carrier Data Network 5, optional Existing Extensions 6, optional Telephone Handsets 7, and Network 8. The Gateway 4 is not limited to using SIP (Session Initiation Protocol), and one of ordinary skill in the art would recognize that there are other protocols for controlling multimedia communication sessions that would work in the Hybrid Hosted System 1.

The Networks 8 may be, for example, a local-area network (LAN), such as a company intranet, a metropolitan area network (MAN), or a wide area network (WAN), such as the Internet. The various computers and nodes illustrated in FIG. 1 may be connected to each other through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., HTTP, TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g, and direct asynchronous connections).

Each of the host CETD 2 and Hosted Services Provider 3 may be any type of computer, Windows-based terminal, network computer, wireless device, information appliance, RISC Power PC, X-device, workstation, mini computer, main frame computer, personal digital assistant, set top box, handheld device, or other computing device that is capable of both presenting information/data and receiving commands. In another embodiment, the CETD 2 is implemented in software executing within a virtual machine environment (e.g., a virtual server) running in a hypervisor on top of one of the computers described above. In addition, either or both of the CETD 2 and Hosted Services Provider 3 may include a visual display device (e.g., a computer monitor), a data entry device (e.g., a keyboard), persistent and/or volatile storage (e.g., computer memory), a processor, and a mouse.

Where the CETD 2 and Hosted Services Provider 3 are computers, they may include a processing unit, main memory, display memory, one or more input/output devices, and a system bus for allowing the various components of the computer to communicate.

In one embodiment, an on-premise computer system may interface via the CETD 2 with the local telephone network (either private or public telephone network, either digital or VoIP). The CETD 2 facilitates keeping voice data local to the customer's premise. Separately, a hosted service running on a computer system, such as the Hosted Service Provider 3, provides command-and-control functionality such that the Hosted Service Provider 3 stores the current and past configurations of the CETD 2 as well as metadata describing the operation of the CETD 2. For example, the metadata may describe (including identifying information) voice data and other data received at the CETD 2 and the routing, queuing, distribution decision making by the CETD 2. In one exemplary embodiment, the Hosted Service Provider 3 indexes and stores the metadata according to the specific configuration of the CETD 2 at the time the metadata was generated.

The CETD 2 receives instructions from the Hosted Service Provider related to routing, recording, and how to otherwise interact with or react to local telephone calls. In one embodiment the Hybrid Hosted System 1 operates as described in Appendix A.

In one embodiment, the Carrier Data Network 5 is a Private Branch Exchange (“PBX”), and the Hybrid Hosted System 1 operates as described in Appendix B. In another embodiment, the Carrier Data Network 5 is a gateway (e.g., a h.323 gate way) for a VoIP network. As an alternative or in addition to the networks that facilitate the forms of synchronous communication described above, the Carrier Data Network 5 may be a data network facilitating asynchronous forms of data communication, such as e-mail, voice mail, video mail, fax-mail. In another embodiment, the Carrier Data Network 5 may be a data network facilitating communication of video data, for example, according to an isochronous data transfer protocol.

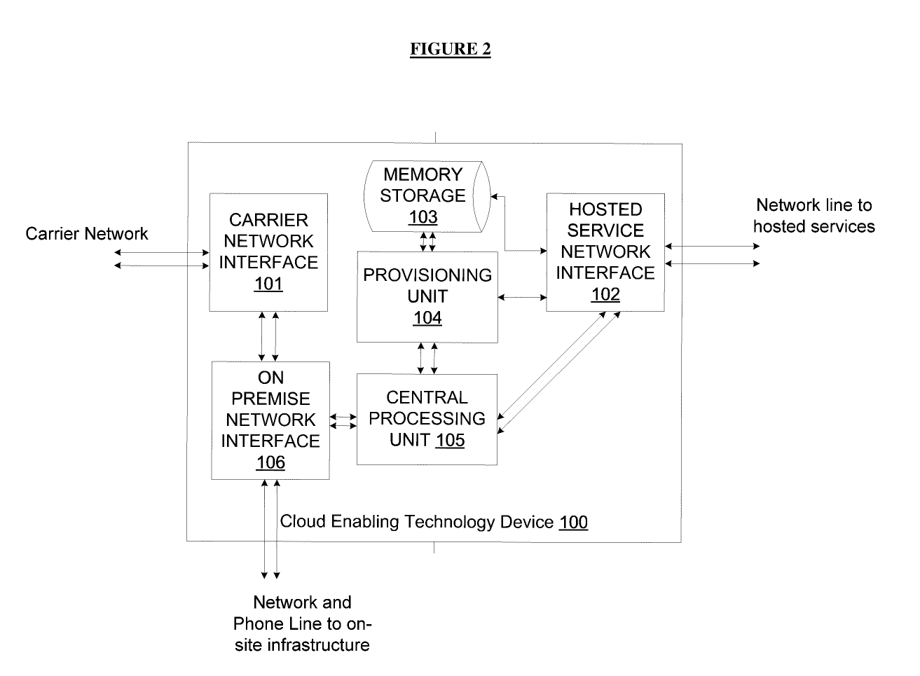

FIG. 2 illustrates a Cloud Enabling Technology Device 100 (“CETD 100”) according to an exemplary embodiment of the invention. The CETD 100 may include a Carrier Data Network Interface 101, Hosted Service Network Interface 102, Memory Storage 103, Provisioning Unit 104, Central Processing Unit 105, and an on Premise Network Interface 106.

The CETD 100 may be installed on premises and executes a provisioning and configuration application, for example, Callfinity's hybrid stub operating system (“OS”). This stub OS communicates with local telecommunications resources, such as T1 lines from an existing phone company, or optionally an on-premise infrastructure provider's PBX. When the OS boots, it may query Callfinity's cloud infrastructure for instructions (i.e., the Hosted Service Provider 3 in FIG. 1), and dynamically provisions itself based upon the configuration that customers implement in the Hosted Service Provider 3. Calls are routed locally to the customer's premise so that the Hosted Service Provider 3 does not have to provide telecom service, minutes, VoIP, or any other such commodity. Rather, the CETD 100 keeps phone calls on-premise, while all the command-and-control may be managed by the Hosted Service Provider 3. In one embodiment the CETD 100 operates as described in Appendix A.

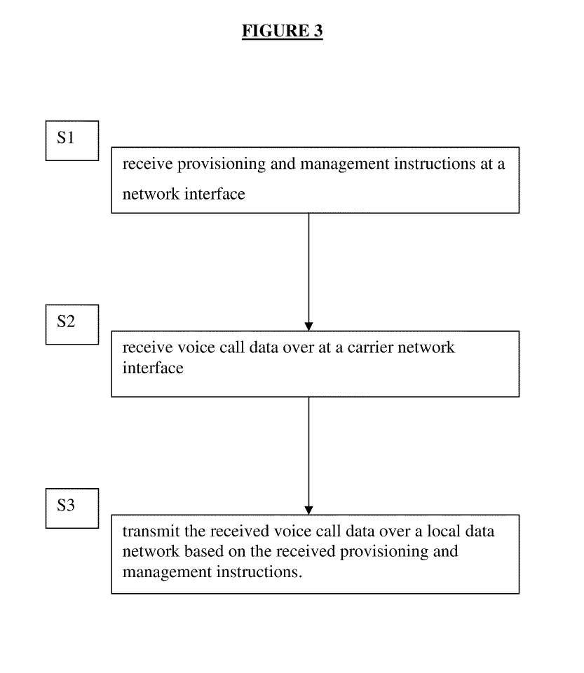

FIG. 3 illustrates an operation of the CETD 100 according to an exemplary embodiment of the invention. In step S1, the CETD 100 receives provisioning and management instructions at a network interface. In step S2, the CETD 100 receives voice call data over at a carrier network interface. In step S3, the CETD 100 transmits the received voice call data over a local data network based on the received provisioning and management instructions.

Embodiments of the invention increase accessibility to command and control functionality, and minimize administrative workload to configure telecommunications applications. Moreover, the hybrid system is more robust in its ability to accommodate failures at the Hosted Service Provider 3, because, should the Hosted Service Provider 3 fail, the CETD 2 continues to operate according to the last provided configuration. Thus, voice call data continues to be queued and routed to customers' local network while the Hosted Service Provider 3 is down.

Embodiments of the invention also provide greater accessibility to telecommunications applications by consolidating access to a centralized hosted service from one or more on-site devices. Embodiments of the invention also provide simplified administration of on-site devices by allowing configuration of all devices from a single centralized hosted service. Other benefits or advantages of the present invention may exist.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include Erlang, C, C++, or Java. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method of providing a hybrid hosting service in a telecommunications system, the method comprising:
receiving provisioning and management instructions from a hosted device at a network interface on a on-premises device;
receiving voice call data at a carrier network interface on the on-premises device; and
transmitting the received voice call data over a data network based on the received provisioning and management instructions.

2. The method of claim 1, wherein the provisioning and management instructions comprise at least one instruction for queuing, distributing, and recording telephone calls.

3. The method of claim 1, wherein the carrier network interface is linked to a private branch exchange.

4. The method of claim 3, wherein the private branch exchange is linked to a public switched telephone network.

5. The method of claim 1, wherein the local data network is a local telephone network.

6. The method of claim 1, wherein the carrier network interface is linked to a gateway for voice-over-IP.

7. The method of claim 1, wherein the carrier network interface is linked to a data network.

8. A system for providing a hybrid hosting service, the system comprising:
a hosted service provider having provisioning and management instructions maintained thereon; and
an on-premises device communicably linked to the hosted service provider and to a carrier network and configured to,
receive the provisioning and management instructions maintained at the hosted service provider; and
transmit voice call data received over the telephone network to one or more devices over a local data network based on the received provisioning and management instructions.

9. The system of claim 8, wherein the provisioning and management instructions comprise at least one instruction for queuing, distributing, and recording telephone calls.

10. The system of claim 8, wherein the carrier network is a private branch exchange.

11. The system of claim 10, wherein the private branch exchange is linked to a public switched telephone network.

12. The system of claim 8, wherein the local data network is a local telephone network.

13. The system of claim 8, wherein the carrier network is a gateway for voice-over-IP.

14. The system of claim 8 wherein the carrier network interface is a data network.

15. A device for providing hybrid hosting service in a telecommunications system, the device comprising:
a network interface configured to receive provisioning and management instructions from a hosted service provider;
a carrier network interface configured to receive voice call data;
a local data network interface;
a provisioning unit configured to control the transmission of the received voice call data to one or more devices over the local data network interface based on the received provisioning and management instructions.

16. The device of claim 15, wherein the provisioning and management instructions comprise at least one instruction for queuing, distributing, and recording telephone calls.

17. The device of claim 15, wherein the carrier network interface is linked to a private branch exchange.

18. The device of claim 17, wherein the private branch exchange is linked to a public switched telephone network.

19. The device of claim 11, wherein the local data network is a local telephone network.

20. The system of claim 15, wherein the carrier network interface is linked to a gateway for voice-over-IP.

21. The system of claim 15 wherein the carrier network interface is linked to a data network.
